(19) United States
(12) Patent Application Publication
(10) Pub. No.: US 2009/0266830 A1
(43) Pub. Date: Oct. 29, 2009

(54) FLUID CONTAINER COMPONENT ASSEMBLY

(76) Inventor: Robert P. Benjey, Dexter, MI (US)

Correspondence Address: JULIA CHURCH DIERKER;DIERKER & ASSOCIATES, P.C., 3331 W. BIG BEAVER RD. SUITE 109, TROY, MI, 48084-2813, US

(21) Appl. No.: 12/108,919

(22) Filed: Apr. 24, 2008

(51) Int. Cl. B65D 25/00; B23P 19/04

(52) U.S. Cl. 220/729; 29/700

(57) ABSTRACT

A fluid container component assembly includes a fluid container component including a body and at least one mounting feature attached to the body. The mounting feature(s) are configured to magnetically engage a portion of a fluid container shell.

### BACKGROUND

The present disclosure relates generally to fluid container components, fluid container assemblies, and a method of mounting a fluid container component to a fluid container.

Fluid containers such as, for example, fuel tanks for partial zero emission vehicles (PZEVs), are often assembled with internally mounted fluid container components such as valves, sensors, tubes, wiring harnesses, filters, pumps, and/or other components. Traditionally, these fluid container assemblies use mounting feature(s) inside the fluid container to suitably mount or otherwise attach the component(s) to the fluid container shell. For example, the fluid container component may be metallurgically mounted to the fluid container via an internal blind weld. In another example, the fluid container component may be mechanically mounted to the fluid container via a fastener. Although metallurgical and mechanical mounts are suitable, these mounting features tend to be relatively complex in design and often may pose difficulties in manufacturing of the fluid container component including the mounting feature.

### SUMMARY

A fluid container component assembly includes a fluid container component including a body and at least one mounting feature attached to the body. The mounting feature(s) are configured to magnetically engage a portion of a fluid container shell.

Also disclosed herein is a fluid container assembly including a fluid container shell and a fluid container component magnetically attached to an interior surface of the fluid container shell.

Further disclosed herein is a method of mounting the fluid container component to a fluid container. The method includes providing the fluid container including a fluid container shell and magnetically attaching the fluid container component to an interior surface of the fluid container shell, thereby mounting the fluid container component to the fluid container.

### BRIEF DESCRIPTION OF THE DRAWINGS

Features and advantages of embodiment(s) of the present disclosure will become apparent by reference to the following detailed description and drawings, in which like reference numerals correspond to similar, though perhaps not identical components. Reference numerals having a previously described function may or may not be described in connection with other drawings in which they appear.

FIG. 1 is a perspective view of an embodiment of a fluid container component assembly as disclosed herein;

FIG. 2 is a cut-away, cross-sectional view of the fluid container component assembly taken along line 2-2 of FIG. 1;

FIG. 3 is a perspective view of another embodiment of the fluid container component assembly;

FIG. 4 is a cut-away, cross-sectional view of the fluid container component assembly taken along line 4-4 of FIG. 3;

FIG. 5 is a perspective view of yet another embodiment of the fluid container component assembly;

FIG. 6 is a cut-away, cross-sectional view of the fluid container component assembly taken along line 6-6 of FIG. 5;

FIG. 7 is a side view of still another embodiment of the fluid container component assembly;

FIG. 8 is a cross-sectional view of the fluid container component assembly taken along line 8-8 of FIG. 7;

FIG. 9 is a cross-sectional, side view of a fluid container assembly according to an embodiment as disclosed herein;

FIG. 9A is a cross-sectional, side view of the fluid container assembly of FIG. 9 depicting another embodiment thereof;

FIG. 10 is a cross-sectional, side view of still another embodiment of the fluid container assembly;

FIG. 11 is a cross-sectional, side view of yet another embodiment of the fluid container assembly; and

FIG. 12 is a cross-sectional, side view of an alternate embodiment of the fluid container assembly.

### DETAILED DESCRIPTION

Embodiment(s) of the fluid container assembly/fluid container component assembly as disclosed herein advantageously use at least one mounting feature for magnetically mounting the fluid container component to the interior surface of the fluid container shell. The mounting feature(s) are suitably strong enough for long term engagement of the fluid container component with the fluid container shell, especially during use thereof under relatively rigorous operating conditions (e.g., when used as a fuel tank in a vehicle being operated on rough terrain). The mounting feature(s) are also suitably sized to allow disengagement of the fluid container component from the fluid container shell for routine maintenance and servicing of the component and/or fluid container. The present fluid container component assembly including the mounting feature(s) is simpler in design than the known mounting arrangements mentioned hereinabove. The assembly also advantageously permits easy assembly of the component with the fluid container without forming holes or other apertures in the fluid container shell for mounting the fuel container component thereto.

As disclosed herein, the fluid container component assembly includes a fluid container component including a body and a mounting feature attached thereto. The fluid container component assembly magnetically engages a portion of a fluid container shell. In one non-limiting embodiment, the fluid container is a fuel tank for a motor vehicle. In other non-limiting embodiments, the fluid container may be a urea tank, a windshield washer reservoir, a coolant reservoir, and/or the like. In connection with this embodiment, the fluid container component will be described as a fuel tank component (though it is to be understood that, in other embodiments, the fluid container component may be any suitable component, as desired). In an embodiment, the fuel tank component may be selected from any component often or commonly used inside the fuel tank, non-limiting examples of which include valves, sensors, tubes (e.g., vent tubes), wiring harnesses, filters, pumps, transmitters, receivers, heaters, coolers, mixers, baffles, reservoirs, nozzles, diffusers, anodes, and cathodes.

With reference now to the drawings, an embodiment of a fluid container/fuel tank component assembly is depicted in FIGS. 1 and 2. Although the embodiment illustrated in FIGS. 1 and 2 uses a particular fuel tank component, it is to be understood that this embodiment, as well as all of the embodiments described hereinbelow, is applicable to any of the fluid container/fuel tank components described herein. It should be noted that the embodiments depicted in FIGS. 1-6 will be described using a valve as the fuel tank component, whereas the embodiments depicted in FIGS. 7-8 will be described using a tube as the fuel tank component.

In the embodiment shown in FIGS. 1 and 2, the fluid container/fuel tank component assembly 10 includes the fluid container/fuel tank component 12 having a body 14. The body 14 includes a mounting surface 16 configured to receive one or more mounting feature(s) 20. The mounting feature 20 may be a magnet or a magnetic coupling. As defined herein, a “magnetic coupling” refers to a component composed of a material that is magnetically responsive to a magnet.

In this embodiment, the mounting surface 16 includes one or more pin(s) 18 formed thereon. It is to be understood that the pin 18 may be a separate piece that is attached to the mounting surface 16, or may be integrally formed with the mounting surface 16, as depicted in FIG. 2. The pin 18 may have a length about equal to the width of the mounting feature 20 and is configured to couple with the mounting feature 20. The pin 18 includes a shaft 22 with at least one retention member 24 formed thereon. The retention members 24 are generally projections extending radially outwardly from the shaft 22. Non-limiting examples of suitable retention members 24 for the pin 18 include prongs, claws, fasteners, or the like, or combinations thereof. In an embodiment, the retention members 24 are formed after the mounting feature 20 is attached to the fuel tank component 12 via, for example, heat staking or any other suitable method known in the art.

The retention member(s) 24 are configured to retain or hold the mounting feature 20 against the mounting surface 16 when the mounting feature 20 is received on the pin 18. Although FIGS. 1 and 2 show two retention members 24, this is merely for illustrative purposes. It is to be understood that any number of retention members 24 may suitably be used.

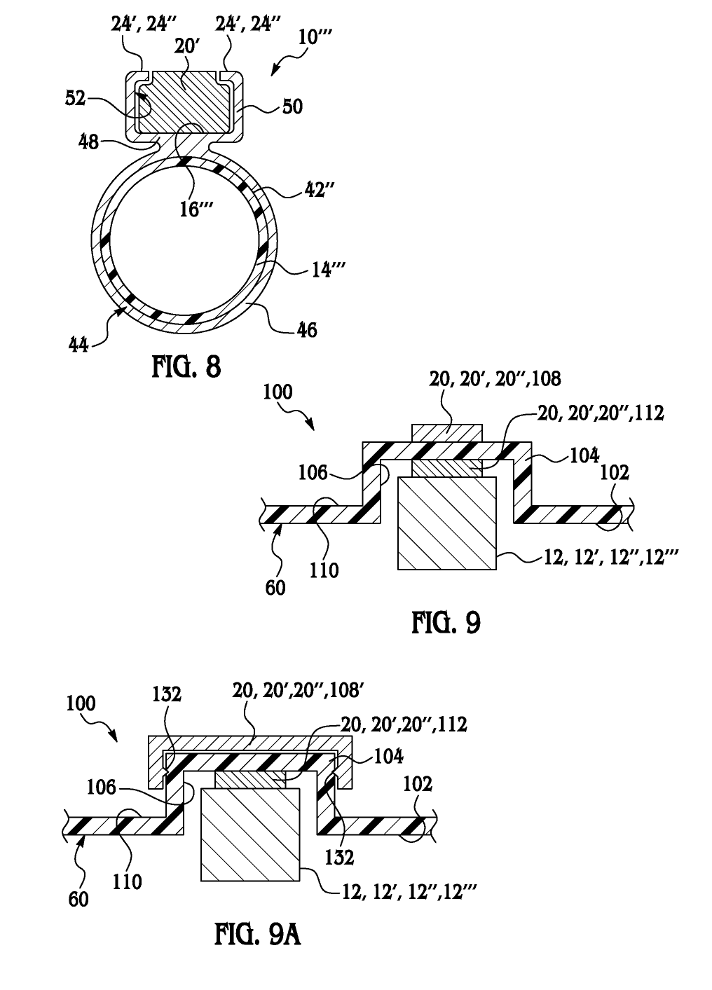

The mounting feature 20 includes a bore 26 formed therethrough and configured to receive the pin 18. The bore 26 includes a circular (e.g., substantially cylindrically-shaped) or non-circular surface 32 that blends into a conically-shaped surface 34 formed by a chamfered edge, cut or machined therein. The substantially cylindrically-shaped surface 32 is configured to receive the shaft 22 of pin 18 when it is received within the bore 26. The retention members 24 contact and engage the conically-shaped surface 34 to retain the mounting feature 20 against the mounting surface 16. In an embodiment, it is to be understood that the mounting feature 20 is desirably retained in the fuel tank component assembly 10 so that very little motion of the mounting feature 20 is allowed to restrict the movement of the fuel tank component 12 when mounted inside a fluid container/fuel tank 60 (e.g., as shown in FIGS. 9-12). This may be advantageous, for example, when the vehicle is being operated under substantially rigorous driving conditions (e.g., off road driving).

In an embodiment, the retention members 24 may be formed from a relatively malleable or elastic material so that the retention members 24 may be temporarily bent or deformed to allow the mounting feature 20 to slide onto the pin 18. The mounting feature 20 is attached to the body 14 when the mounting feature 20 contacts the mounting surface 16 and the retention members 24 are bent or substantially returned to their original shape until they contact the conically-shaped surface 34. The mounting feature 20 is thereby held on the pin 18 and against the mounting surface 16. It is to be understood that the mounting feature 20 may be attached to the body 14 using a variety of other methods. In another non-limiting example, the method includes a thermal attaching means, e.g., heat staking the pin 18 to retention member 24. In another embodiment, a groove is formed around the outer diameter of mounting feature 20. The retention members 24 may then contact the groove and hold the mounting feature 20 against the mounting surface 16.

FIGS. 3 and 4 depict another embodiment of the fluid container/fuel tank component assembly 10′ as disclosed herein. In this embodiment, the body 14′ of the fluid container/fuel tank component 12′ includes the mounting surface 16′ having an annular flange 36 formed thereon or integrally therewith. The flange 36 is generally made of a non-magnetic or a magnetically transparent material that will not impede the magnetic coupling between fluid container shell and the fluid container/fluid tank component 12′. The flange 36 is positioned substantially normal to the mounting surface 16′ and may extend outwardly from the mounting surface 16′ at a distance about equal to the width of the mounting feature 20′. As shown in FIG. 3, the flange 36 includes two retention members 24′ attached thereto or integrally formed thereon. It is to be understood, however, that any suitable number of retention members 24′ may be used in the embodiment depicted in FIGS. 3 and 4. Non-limiting examples of the retention members 24′ include prongs, claws, fasteners, an annular lip, or the like, or combinations thereof.

In the embodiment depicted in FIGS. 3 and 4, a recess 40 is defined by the mounting surface 16′ and an inner surface 38 of the annular flange 36. Recess 40 is configured to receive the mounting feature 20′. As depicted in the drawings, this embodiment of the mounting feature 20′ has a generally rounded or circular shape, and the recess 40 is complementarily shaped to accommodate the mounting feature 20′.

As shown in FIG. 4, the mounting feature 20′ includes at least one recessed step 42, e.g., machined or otherwise formed therein, where each step 42 is configured to receive a respective retention member 24′.

In this embodiment, the fabrication of the fluid container/fuel tank component assembly 10′ may be achieved by temporarily bending or otherwise deforming the retention members 24′ so that the retention members 24′ expose substantially the entire recess 40. The mounting feature 20′ is placed inside the recess 40 so that the side opposed to the side having the step 42 formed therein contacts the mounting surface 16′. The retention members 24′ may then be substantially returned to their original shape and inserted into their respective steps 42 formed in the mounting feature 20′, thereby retaining the mounting feature 20′ in the recess 40 and attaching the mounting feature 20′ to the body 14′.

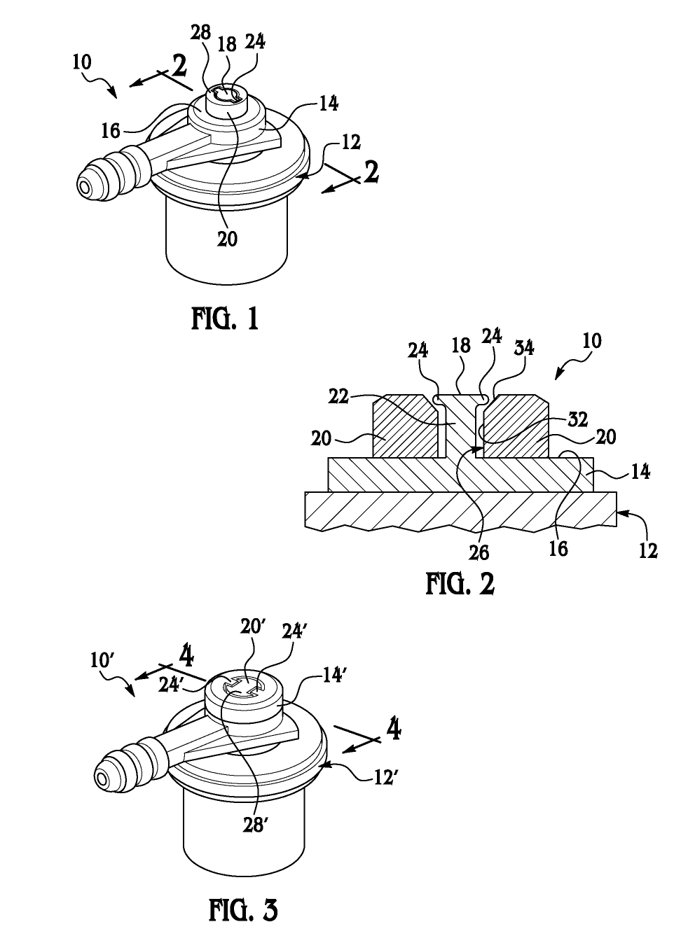

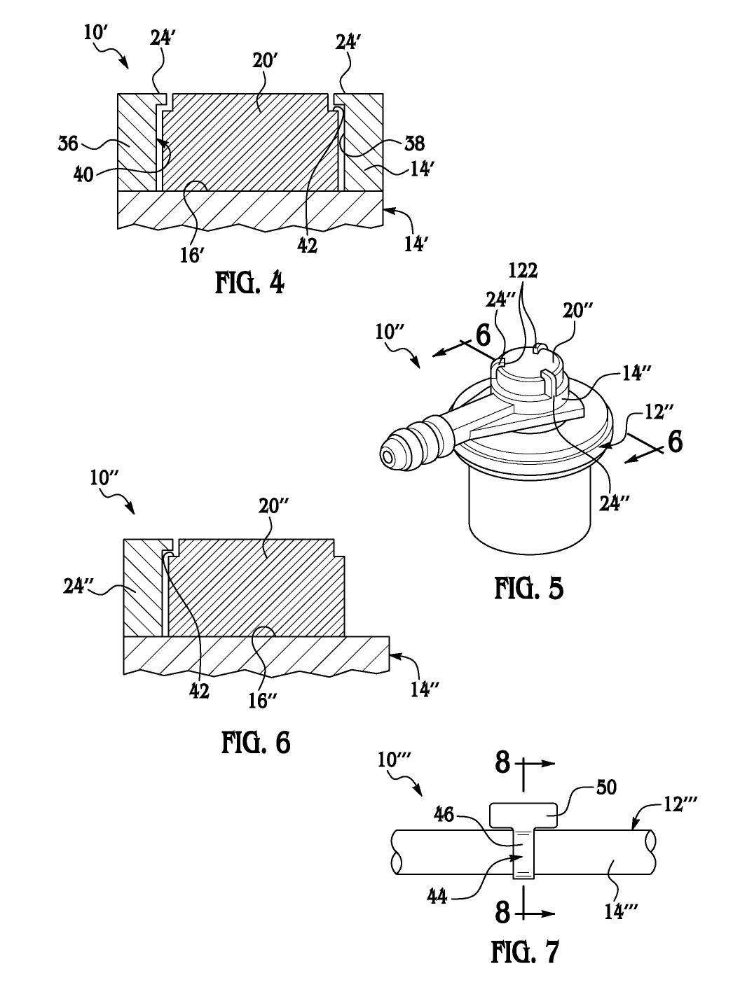

FIGS. 5 and 6 depict yet another embodiment of the fluid container/fuel tank component assembly 10″. This embodiment is substantially similar to that depicted in FIGS. 3 and 4, except that three or more substantially flexible retention members 24″ project directly from the mounting surface 16″, thereby resembling a cage configured to receive the mounting feature 20″. Each retention member 24″ includes a head 122 configured to engage the mounting feature 20″.

In a non-limiting example, the mounting feature 20″ includes three steps 42′ machined or otherwise formed therein, each configured to receive a head 122. In another non-limiting example, the mounting feature 20″ may include an annular step (not shown) formed therein. The heads 122 engage their respective step 42′ when the mounting feature 20″ is retained within the cage formed by the retention members 24″.

In this embodiment, the fluid container/fuel tank component assembly 10″ may be achieved by temporarily bending or otherwise deforming the retention members 24″ to expose the mounting surface 16″. The mounting feature 20″ is placed between the retention members 24″ (i.e., within the cage) so that the side opposed to the side having the step 42′ contacts the mounting surface 16′. The retention members 24″ may then be substantially returned to their original shape and inserted to their respective step 42′. The retention members 24″ are thereby retained in the cage and attach the mounting feature 20″ to the body 14″.

In a non-limiting example, the mounting feature 20′, 20″ may otherwise be retained within the recess 40 (with respect to the embodiment depicted in FIGS. 3 and 4) or the cage (with respect to the embodiment depicted in FIGS. 5 and 6) via a sonic weld, and/or the like.

FIGS. 7 and 8 depict still another embodiment of the fluid container/fuel tank component assembly 10′″. In this embodiment, the fluid container/fuel tank component 12′″ is depicted as a tube. This has been done for illustrative purposes and to demonstrate the versatility of the various fluid container/fuel tank components 12, 12′, 12″, 12′″ with the fuel tank component assemblies 10, 10′, 10″, 10′″. It is, again, to be understood that any of the fuel tank components listed hereinabove may also be used with this and any of the other embodiments disclosed herein.

As shown in FIGS. 7 and 8, the fluid container/fuel tank component assembly 10′″ includes the fluid container/fuel tank component 12′″ including the body 14′″ and the mounting feature 20′ (which is substantially similar to the mounting feature 20′ depicted in FIGS. 3-4) attached thereto. The fuel tank component assembly 10′″ further includes a fastener 44 attached to the body 14′″. The fastener 44 may include a strap or ring 46 having a platform 48 (attached thereto or integrally formed therewith) including a mounting surface 16′″. The fastener 44 may be slid onto the body 14′″, or the ring 46 may be split into two legs (not shown) that are fit over the body 14′″. If desired, the fastener 44 may also be tightened using, for example, a tie.

An annular flange 50 positioned substantially normal to the platform 48 is attached thereto or integrally formed thereon and extends generally outwardly therefrom. A recess 52 is defined by the mounting surface 16′″ and the interior surface of annular flange 50, and is configured to receive the mounting feature 20′. This is similar to the recess 40 for the embodiment described hereinabove.

As shown in FIG. 6, the annular flange 50 includes at least one retention member 24′, 24″ (as described above in conjunction with either of the embodiments depicted in FIGS. 3 and 4 or in FIGS. 5 and 6). The retention members 24′, 24″ are configured to hold the mounting feature 20′ against the mounting surface 16′″ when the mounting feature 20′ is received within the recess 52. The mounting feature 20′ is assembled or otherwise attached to the body 14′″ as similarly described for any of the embodiment(s) herein.

It is to be understood that it is within the scope and spirit of the present disclosure that more than one pin 18, recess 40, 52, the cage, and/or fastener 44 may be provided in the fluid container/fuel tank component assembly 10, 10′, 10″, 10′″, thereby allowing more than one mounting feature 20, 20′, 20″ to be attached thereto.

Further, it is to be understood that the mounting surface 16, 16′, 16″, 16′″ in any of the embodiments disclosed herein may be a substantially flat or contoured, continuous or discontinuous surface, (some non-limiting examples of discontinuous surfaces include screens, mesh, donut shapes, spring surfaces, etc.). As such, it is also to be understood that the mounting surface 16, 16′, 16″, 16′″ is not limited to a single surface, but may encompass several surfaces that contact and/or desirably restrain the mounting feature 20, 20′, 20″.

Still further, it is to be understood that the assembly of the fluid container/fuel tank component assembly 10, 10′, 10″, 10′″ depicted in FIGS. 1-8 are just a few examples of several methods of forming the fluid container/fuel tank component assembly 10, 10′, 10″, 10′″. Regardless of the method selected, the mounting feature 20, 20′, 20″ is positioned in the fluid container/fuel tank component assembly 10, 10′, 10″, 10′″ so that the mounting feature 20, 20′, 20″ is in contact with, or substantially close to the fluid container shell 104 (described below in conjunction with FIGS. 9-12). This reduces the magnetic gap between the mounting feature 20, 20′, 20″ and the fluid container shell 104 and increases the magnetic strength between them.

With reference now to FIGS. 9-12, a fluid container assembly 100, 100′, 100″, 100′″ including a fluid container component 12, 12′, 12″, 12′″ is magnetically attached to an interior surface 102 of a fluid container shell 104 of fluid container 60 (one non-limiting example of which is a fuel tank for a motor vehicle). It is to be understood that the fluid container shell 104 may be formed from any suitable single or multi-layer material, as desired. In an embodiment, the fluid container shell 104 is a single layer of a polymeric material. In another embodiment, the fluid container shell 104 may be formed from multiple layers (not shown) of polymeric materials.

It is to be understood that the fluid container 60 for the fluid container assembly 100, 100′, 100″, 100′″ as disclosed herein may be used to hold or store a variety of fluids including, but not limited to, fuels (e.g., gasoline, propane, natural gas, hydrogen, etc.), transmission fluids, windshield wiper fluids, antifreeze fluids, brake fluids, power steering fluids, oils, urea-containing fluids, and the like.

In an embodiment, the fluid container shell 104 may further include a recess 106 formed therein. The recess 106 may be, but is not necessarily configured to receive at least a portion of the fluid container component 12, 12′, 12″, 12′″. It is to be understood that the recess 106 may be formed as deep or as shallow as desired. Without being bound by any theory, it is believed that the depth and the shape of the recess 106 also may substantially improve the magnetic path for coupling the magnetic feature/magnet 20, 20′, 20″, 112 with the fluid container shell 104, thereby increasing the magnetic attraction force between them. It is also to be understood that the fluid container shell 104 may be formed without a recess 106. The recess 106 may facilitate the loading and mounting of the fluid container component 12, 12′, 12″, 12′″ to the fluid container shell 104.

The fluid container component 12, 12′, 12″, 12′″ is mounted inside the fuel tank 100, 100′, 100″, 100′″ by magnetically attaching the fluid container component 12, 12′, 12″, 12′″ to the interior surface 102 of the fluid container shell 104. FIGS. 9-12 provide five alternate, non-limiting configurations for the fluid container assembly 100, 100′, 100″, 100′″. It is to be understood that the fluid container component 12, 12′, 12″, 12′″ depicted in FIGS. 9-12 may be any suitable fluid container component, as desired, such as any of the components mentioned above, e.g., valves, tubes, pumps, etc., or combinations thereof.

Referring again to FIG. 9, the fluid container assembly 100 includes a mounting feature/magnetic coupling 20, 20′, 20″, 108 disposed on an exterior surface 110 of the fluid container shell 104. In a non-limiting example, the magnetic coupling 108 may be a generally rounded or circular piece or slab of magnetically responsive metal (such as, for example, steel having a suitable carbon content so that the steel is sufficiently magnetically responsive) that is mechanically and/or chemically attached to the exterior surface 110 of the fluid container shell 104. If the magnetic coupling 108 is chemically attached to the shell, the chemical attachment means does not substantially interfere with the magnetic attraction of the magnetic coupling 108. In a non-limiting example, the chemical attachment means is glue.

In another non-limiting example, the magnetic coupling 108 may be a metallic cup 108′ (shown in FIG. 9A) disposed on the exterior surface 110 of the fluid container shell 104 surrounding the recess 106 in a substantially complementary-fit configuration. In an example, the metallic cup 108′ may be mechanically attached to the exterior surface 110 of the fluid container shell 104. This may be accomplished by forming a plurality of barbs 132 on the surface of the metallic cup 108′ and snap-fitting the barbs 132 into complementary-shaped recesses 134 formed into the exterior surface 110 during fabrication of the fluid container shell 104. In another example, the metallic cup 130 may be attached to the fluid container shell 104 by heat staking, ultrasonic welding, and/or the like. This may be accomplished by including a plurality of holes (not shown) in the metallic cup 108′ and molding the metallic cup 108′ to the exterior surface 110, either before, during or after fabrication of the fluid container shell 104.

The fluid container component 12, 12′, 12″, 12′″ includes a mounting feature/magnet 20, 20′, 20″, 112 and is disposed inside the fluid container shell 104 and positioned against the interior surface 102 thereof. The magnet 112 is aligned with and magnetically engages the magnetic coupling 108 disposed on the exterior surface 110 of the fluid container shell 104, thereby mounting the fluid container component 12, 12′, 12″, 12′″ thereto.

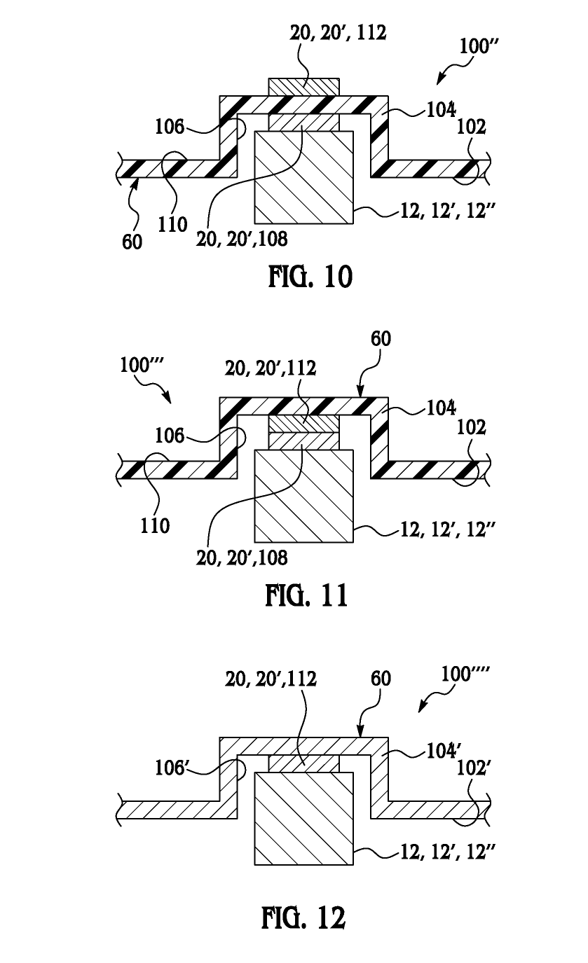

In still another embodiment, and as shown in FIG. 10, the magnet 112 is disposed on and attached to the exterior surface 110 of the fluid container shell 104, and the magnetic coupling 108 is attached to the fluid container component 12, 12′, 12″, 12′″. The fluid container component 12, 12′, 12″, 12′″ including the magnetic coupling 108 is disposed inside the fluid container shell 104, and the magnetic coupling 108 is aligned with and magnetically engages the magnet 112, thereby mounting the fluid container component 12, 12′, 12″, 12′″ to the fluid container shell 104.

In yet a further embodiment, and as provided in FIG. 11, the magnet 112 is disposed on, and attached to the interior surface 102 of the fluid container shell 104. Similar to the embodiment depicted in FIG. 8, the magnetic coupling 108 is attached to fluid container component 12, 12′, 12″, 12′″ and magnetically engages the magnet 112, thereby mounting the fluid container component 12, 12′, 12″, 12′″ to the fluid container shell 104.

With reference now to FIG. 12, the fluid container assembly 100′″includes a fluid container shell 104′ made of a magnetically responsive metal such as, for example, steel. In this embodiment, the fluid container component 12, 12′, 12″, 12′″ includes the magnet 112 attached thereto. Since the fluid container shell 104′ is made of a magnetically responsive material (i.e., steel), a magnetic coupling 108 attached to the fluid container/fuel tank shell 104′ is not necessary. The fluid container assembly 100′″ may be assembled by placing the fluid container component 12, 12′, 12″, 12′″ including the magnet 112 attached thereto into the recess 106′ and magnetically engaging the magnet 112 with the interior surface 102′ of the fluid container shell 104′.

It is to be understood that to achieve desirable magnetic coupling or engagement between the mounting feature/magnet 20, 20′, 20″ 112 and the mounting feature/magnetic coupling 20, 20′, 20″ 108 in any of the embodiments herein, the magnet 112 is selected to exhibit a suitable magnetic force. In an embodiment, this magnetic force is strong enough to allow attachment of the fluid container/fuel tank component 12, 12′, 12″, 12′″ to the fluid container/fuel tank 60 and substantially maintain that magnetic attachment even during rigorous operating conditions. The magnet 112 may also, however, be weak enough to facilitate removal of the fluid container component 12, 12′, 12″, 12′″ for maintenance and servicing of any of the parts of the fluid container assembly.

To achieve this magnetic balance, the magnet 112 is selected based on the ratio of the magnetic holding force to the weight of the fluid container component 12, 12′, 12″, 12′″. The magnet may generally be selected based on its magnetic force being sufficient to attach the fluid container component 12, 12′, 12″, 12′″ to the fuel container shell 104. In some instances, the magnet 112 may have a magnetic force of at least about 15 lbs. In other instances, the magnetic force of the magnet 112 may be higher. In yet other instances, the magnetic force of the magnet 112 may be lower. Further magnet 112 may have a suitably high enough exposed surface area for desirable magnetic engagement with the magnetic coupling 108.

FIGS. 1-12 semi-schematically depict the several parts of the fluid container assembly 100, 100′, 100″, 100′″ including the mounting feature 20, 20′, 20″. It is to be understood that the mounting feature 20, 20′, 20″, e.g., when the mounting feature 20, 20′, 20″ is a magnet 112, may be substantially thin (e.g., the magnet 112 may have a thickness of about 6 mm). It is also to be understood, however, that the thickness of the magnet 112 depends, at least in part, on the type of magnet selected. To maximize the retention power of the magnet 112 without making the fluid component assembly bulky, the magnet 112 may be substantially larger in exposed surface area than in thickness.

It is to be understood that the term “attach/attached”, “mounted/mounting”, and/or the like are broadly defined herein to encompass a variety of divergent attachment arrangements and assembly techniques. These arrangements and techniques include, but are not limited to (1) the direct attachment between one component and another component with no intervening components therebetween; and (2) the attachment of one component and another component with one or more components therebetween, provided that the one component being “attached to” the other component is somehow operatively attached to the other component (notwithstanding the presence of one or more additional components therebetween).

While several embodiments have been described in detail, it will be apparent to those skilled in the art that the disclosed embodiments may be modified and/or other embodiments may be possible. Therefore, the foregoing description is to be considered exemplary rather than limiting.

What is claimed is:

1. A fluid container component assembly, comprising:
a fluid container component including a body; and
at least one mounting feature attached to the body and configured to magnetically engage a portion of a fluid container shell.

2. The fluid container component assembly as defined in claim 1 wherein the at least one mounting feature has a magnetic force sufficient to attach the fluid container component to the fluid container shell during use of the fluid container.

3. The fluid container component assembly as defined in claim 1 wherein the at least one mounting feature is a magnet or a magnetic coupling.

4. The fluid container component assembly as defined in claim 1 wherein the fluid container component is selected from a valve, a sensor, a tube, a wiring harness, a filter, a pump, a transmitter, a receiver, a heater, a cooler, a mixer, a baffle, a reservoir, a nozzle, a diffuser, an anode, a cathode, or combinations thereof.

5. A fluid container assembly, comprising:
a fluid container shell; and
a fluid container component magnetically attached to an interior surface of the fluid container shell.

6. The fluid container assembly as defined in claim 5 wherein the fluid container shell includes at least one magnetic coupling disposed on an exterior surface of the fluid container shell.

7. The fluid container assembly as defined in claim 6 wherein the fluid container component includes at least one magnet disposed on a surface thereof, and wherein the at least one magnet engages with the at least one magnetic coupling of the fluid container shell.

8. The fluid container assembly as defined in claim 6 wherein the fluid container shell includes a recess formed in an internal surface thereof.

9. The fluid container assembly as defined in claim 8 wherein the magnetic coupling is a metallic cup disposed on the exterior surface of the fluid container shell and surrounding, in a substantially complementary-fit configuration, a prominence corresponding to the recess.

10. The fluid container assembly as defined in claim 8 wherein the magnetic coupling is a metallic cup including a plurality of barbs formed thereon, and wherein the metallic cup is at least one of mechanically attached to the fluid container shell, or thermally attached to the fluid container shell.

11. The fluid container assembly as defined in claim 10 wherein the metallic cup includes a depth and a shape that substantially improves a magnetic path for magnetically attaching the fluid container component to the interior surface of the fluid container shell, thereby substantially increasing the magnetic attraction force between them.

12. The fluid container assembly as defined in claim 5 wherein the fluid container shell includes at least one magnet disposed on an interior surface thereof, an exterior surface thereof, or combinations thereof.

13. The fluid container assembly as defined in claim 12 wherein the fluid container component includes at least one magnetic coupling disposed on a surface thereof, and wherein the at least one magnetic coupling engages with the at least one magnet of the fluid container shell.

14. The fluid container assembly as defined in claim 5 wherein the fluid container shell is formed from a magnetically responsive material, and the fluid container component includes at least one magnet disposed on a surface thereof, and wherein the at least one magnet engages with the magnetically responsive fluid container shell.

15. The fluid container assembly as defined in claim 5 wherein the fluid container component includes one of a magnet or a magnetic coupling attached to a surface thereof and the fluid container shell includes the other of the magnet or the magnetic coupling attached to a surface thereof; and wherein the magnet or the magnetic coupling attached to the fluid container component is positioned thereon to thereby substantially reduce a magnetic gap between the magnet or the magnetic coupling attached to the fluid container component and the other of the magnet or the magnetic coupling attached to the fluid container shell.

16. A method of mounting a fluid container component to a fluid container, the method comprising:
providing a fluid container including a fluid container shell; and
magnetically attaching the fluid container component to an interior surface of the fluid container shell, thereby mounting the fluid container component to the fluid container.

17. The method as defined in claim 16, further comprising:
disposing at least one magnet on the interior surface of the fluid container shell, an exterior surface of the fluid container shell, or combinations thereof; and
disposing at least one magnetic coupling on a surface of the fluid container component.

18. The method as defined in claim 16, further comprising:
disposing at least one magnetic coupling on an exterior surface of the fluid container shell; and
disposing at least one magnet on a surface of the fluid container component.

19. The method as defined in claim 18 wherein the fluid container shell includes a recess on an interior surface thereof, and wherein the magnetic coupling is a metallic cup, the method further comprising:
disposing the metallic cup on the exterior surface of the fluid container shell and surrounding a prominence corresponding to the recess; and
at least one of mechanically attaching the metallic cup to the exterior surface, or thermally attaching the metallic cup to the exterior surface.

20. The method as defined in claim 16 wherein the fluid container shell is made of a magnetically responsive material, and the method further comprises disposing at least one magnet on a surface of the fluid container component.

21. The method as defined in claim 16, further comprising:
disposing one of a magnet or a magnetic coupling on a surface of the fluid container shell; and
disposing the other of the magnet or the magnetic coupling on a surface of the fluid container component;
wherein the magnet or magnetic coupling attached to the fluid container component is positioned thereon to thereby substantially reduce a magnetic gap between the magnet or the magnetic coupling attached to the fluid container shell and the other of the magnet or the magnetic coupling attached to the fluid container component.
